(19) United States
(12) Patent Application Publication
(10) Pub. No.: US 2005/0039108 A1
(43) Pub. Date: Feb. 17, 2005

(54) Fast tag entry in a multimodal markup language editor

(75) Inventor: Thomas R. Hudson, Cary, NC (US)

Correspondence Address: CHRISTOPHER & WEISBERG, PA, 200 E. LAS OLAS BLVD, SUITE 2040, FT LAUDERDALE, FL, 33301, US

(73) Assignee: International Business Machines Corporation, Armonk, NY (US)

(21) Appl. No.: 10/641,574

(22) Filed: Aug. 15, 2003

(51) Int. Cl. G06F 15/00

(52) U.S. Cl. 715/500

(57) ABSTRACT

A method, system and apparatus for fast tag entry in a multimodal markup language document editor. A multimodal markup language document editor which has been configured for fast tag entry can include multiple views, the views including at least one source view and at least one WYSIWYG view. A fast tag entry processor can be coupled both to the WYSIWYG view and the source view. The processor can be configured to create a buffer such as a pop-up source window over the WYSIWYG view through which a tag definition can be textually specified without requiring a context switch to the source view. The processor further can be configured to insert the textually specified tag definition in a markup language document in the editor. Finally, the processor can be configured to cause the WYSIWYG view to re-render a representation of the markup language document to reflect the textually specified tag definition.

### BACKGROUND OF THE INVENTION

1. Statement of the Technical Field

The present invention relates to the field of multimodal markup language editors and more particularly to a tag editing feature within a multimodal markup language editor.

2. Description of the Related Art

Multimodal markup language editors are well-known tools mostly utilized in the creation of markup language documents designed for distribution over the global Internet. The prototypical markup language document includes embedded instructions or tags which specify how referenced content ought to be presented in a content browser. Markup language tags also can specify sources of content to be presented within the content browser, as well as structural configurations for content within a content browser. It is the principal function of the content browser to interpret and enforce the specifications of markup language tags embedded within a markup language document.

When first popularized, markup language documents were created manually in the same manner as traditional source code using conventional text editors. Markup language documents, unlike conventional source code, however include unique programmatic structure in which pairs of markup language tags can enclose context which is to be defined by the markup language tags. Thus, when editing a markup language document directly, it should be no surprise often developers omit tags or misplace tags unintentionally. Though no “compiler” error will result, the misplacement or omission can produce unpredictable results. Hence, multimodal markup language editors were developed to facilitate the creation of markup language documents.

Multimodal markup language document editors minimally provide a two-way tool disposed in an integrated development environment. Each mode of development can provide a different view of the content as defined by embedded tags which can range from a pure source code view to a preview of the markup language document in a content browser (“What You See Is What You Get” or “WYSIWYG”). Typically, markup language document developers prefer to work in an intermediate mode in which the content can be viewed in additional to graphically embedded tags. In the intermediate mode, an assertion of a particular tag can automatically result in the creation of a companion tag in the markup language document so as to avoid unintentionally misplaced or omitted tags. Notably, most multimodal markup language document editors generate changes implemented in one view across all other views in the editor.

Most conventional multimodal markup language document editors provide for the hot-key insertion of a markup language tag. Just as in the case of a word processor, in the conventional multimodal markup language the combination striking of a control key and a letter can invoke the associated tag. For example, the striking of CONTROL+B can invoke the insertion of a bolding markup language tag. While the association of CONTROL+B with “bold face” will be apparent to most, remembering the hot-key sequence for many tags can be difficult for many. Moreover, where the application of a markup language tag is to be applied to subsequently inserted text rather than to selected text, the invocation of the markup language will not be visually apparent until text is subsequently provided.

To properly insert a tag pair in a markup language document in a multimodal editor, many tags require the use of a dialog box invoked through a menu bar, tool bar or through another dialog box. Even where a dialog box is not required to specify a tag, at least a selection of a menu bar or tool bar entry will be required. Yet, for many, to select a menu bar or tool bar entry can interrupt the workflow of developing a markup language document. Of course, the markup language document developer always can code directly through the source code view of the multimodal editor, but to do so would defeat the purpose of the use of an editor and can invite the problems associated with traditional text editing of a markup language document.

Developers prefer to edit markup in a WYSIWYG view, but sometimes developers require or prefer a source view when editing granular elements of markup. It will be recognized that some development tasks are most efficiently performed in the WYSIWYG view while other tasks are better suited to a source view. In any case, to switch between views, referred to herein as a context switch, can interrupt the flow of development and can be a hindrance to the efficient coding of markup. For instance, locating a phrase or tag in a source view can be difficult when changing from a WYSIWYG view. Moreover, switching from mouse to keyboard to mouse can further interrupt to flow of development.

### SUMMARY OF THE INVENTION

The present invention addresses the deficiencies of the art in respect to tag insertion in a multimodal markup language document editor and provides a novel and non-obvious method, system and apparatus for fast tag entry in a multimodal markup language document editor. A multimodal markup language document editor which has been configured for fast tag entry can include multiple views, the views including at least one source view and at least one WYSIWYG view.

Importantly, a fast tag entry processor can be coupled both to the WYSIWYG view and the source view. The processor can be configured to create a buffer, such as an inline text insertion point or a pop-up source window over the WYSIWYG view through which a tag definition can be textually specified. The processor further can be configured to insert the textually specified tag definition in a markup language document in the editor. Finally, the processor can be configured to cause the WYSIWYG view to re-render a representation of the markup language document to reflect the textually specified tag definition.

A method for automatically inserting markup language tags in selected text in a markup language document can include detecting an attempt to insert text in a text element of a WYSIWYG view of a markup language document. Responsive to the detection, a buffer can be created in the WYSIWYG view without replacing the WYSIWYG view or requiring a context switch to a source view. A textual definition of a tag can be accepted within the buffer and the textual definition of the tag can be applied to the markup language document. Finally, the buffer can be closed and the WYSIWYG view can be re-rendered to reflect the applied textual definition of the tag in the markup language document.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute part of the this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is block diagram illustrating a system for fast tag entry in a multimodal markup language document editor;

FIG. 2 is a flow chart illustrating a process for fast tag entry in the multimodal markup language document editor of FIG. 1; and,

FIG. 3 is a pictorial illustration of a multimodal markup language editor configured for fast tag entry in accordance with the present invention.

### DETAILED DESCRIPTION OF THE PREFERRED EMBODIMENTS

The present invention is a fast tag entry system, process and apparatus configured for use with a multimodal markup language document editor. In accordance with the present invention, responsive to the activation of an accelerator key in a text element in the WYSIWYG view of the editor, a text input buffer can be created in which the source of a tag element can be defined textually without switching to a source view in the editor. Subsequent to the textual definition of the tag in the buffer, the source markup can be modified with the definition and the resulting tag can be applied in the WYSIWYG view of the editor. In this way, the tag can be defined without requiring a context switch between the WYSIWYG view and a source view.

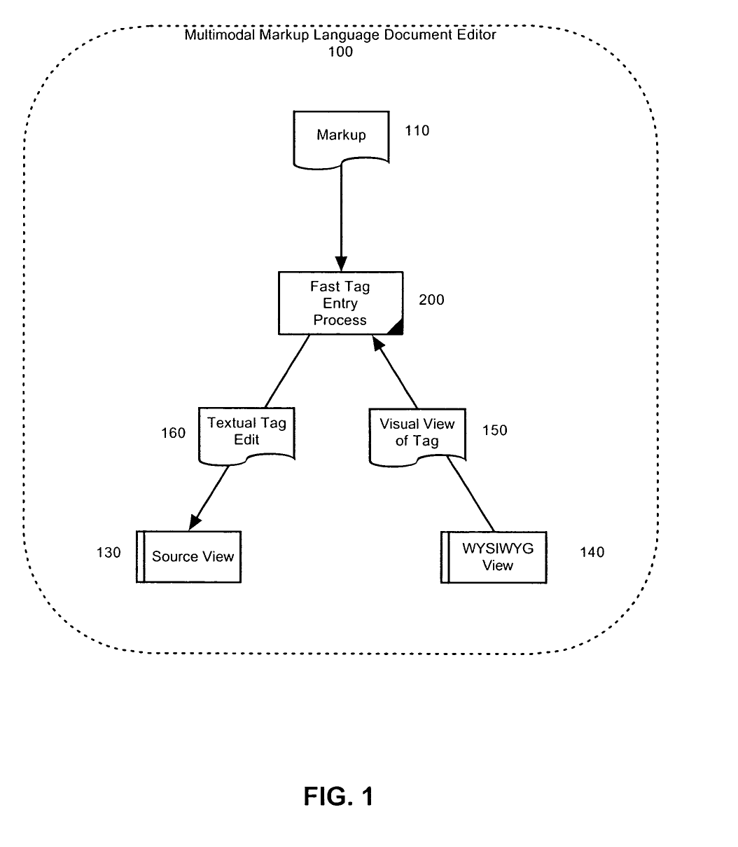

FIG. 1 is block diagram illustrating a system for fast tag entry in a multimodal markup language document editor. The system of the present invention can include a multimodal markup language document editor 100 configured to process fast tag entries in a markup language document 110 in the editor 100. A fast tag entry processor 200 can be disposed in the editor 100 can configured for handling fast tag entry when editing the markup language document 110. Notably, the editor 110 can include both a source view 130 and a WYSIWYG view 140. In the source view 130, the text of the markup 110 can be viewed as “source code” and the markup 110 can be manipulated directly by the developer. In the WYSIWYG view 140, by comparison, a graphical representation of the markup 110 can be presented and the markup can be manipulated indirectly through the interaction by the developer with graphical elements and menu entries.

In operation, the editor 100 can be placed in fast tag entry mode, for example by selecting a menu entry or striking a hot-key combination. Preferably, responsive to the insertion of the “<” character in a textual element of the WYSIWYG view 140, the editor 100 can be placed in fast tag entry mode. Once in the fast tag entry mode, the fast tag entry processor 200 can detect the insertion of text in the textual element. Responsive to the detection, the fast tag entry processor 200 can create a text input buffer, for instance in line in the visual representation of the tag in the WYSIWYG view 140, or as another example, in a pop-up source window displayed over the visual layout of the WYSIWYG view 140 in which the source of a tag element can be directly entered without requiring the use of the graphical elements of the WYSIWYG view 140.

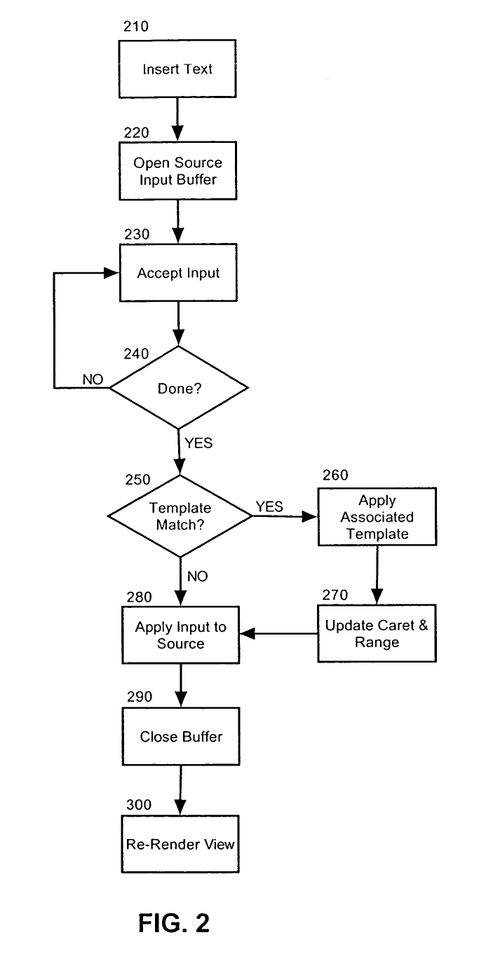

The resulting textual tag edit 160 can be applied to the markup 110 in the source view 130 without requiring a context switch to the source view. Subsequently, the resulting textual tag edit 160 can be reflected visually 150 in the WYSIWYG view 140. Once the buffer has been closed and the changes to the visual view of the tag 150 have been presented in the WYSIWYG view 140, the insertion caret can be repositioned in the textual element of the WYSIWYG view 140 to accommodate any changes to the textual element. In more particular illustration, FIG. 2 is a flow chart illustrating a process for fast tag entry in the multimodal markup language document editor of FIG. 1.

In block 210, a text insertion event can be detected. The event can be triggered responsive to the insertion of text in a text element in the WYSIWYG view of the multimodal markup language document editor when the editor has been placed in fast tag entry mode. Responsive to the detection of the insertion event, in block 220 a buffer can be created in the WYSIWYG view of the editor. Once open, the buffer can accept the insertion of text in block 230 such as through the keyboard or other text input device. In block 240, the buffer can continue to accept the insertion of text until the entry of a “fast tag” has been completed. Notably, the entry can be completed either manually through an indication by the developer, or automatically, for instance by detecting the close tag character, “>”.

In a preferred arrangement, prior to re-rendering the WYSIWYG view to reflect the changes to the tag provided through the buffer, additional post-processing can be performed on the text in the tag. The additional post-processing can include validating the tag definition specified in the buffer, or the automatic modification of the tag definition specified in the buffer. Specifically a set of templates can be defined for modifying inserted text in the tag to an expanded or contracted form. For instance, the entire text or a portion of the text can be matched to a filter in the template. Once matched in decision block 250, the associated template can be applied in block 260 to modify the text, for instance by addition text. In block 270, the insertion caret can be updated in the WYSIWYG view to reflect the added text.

In block 280, once the entry of the tag and any required post-processing have been completed in respect to the buffer, the textual input provided in the buffer can be applied to the underlying markup language document and in block 290 the buffer can be closed, once again revealing the full view of the WYSIWYG view. Finally, in block 300 the WYSIWYG view can be re-rendered to reflect any changes provided through the buffer. Significantly, in the basic configuration of the present invention, the textual input provided in the buffer can be reflected in the WYSIWYG view without switching to a source view. Thus, the developer can continue to edit the markup through the WYSIWYG view without having had to switch contexts to the source view.

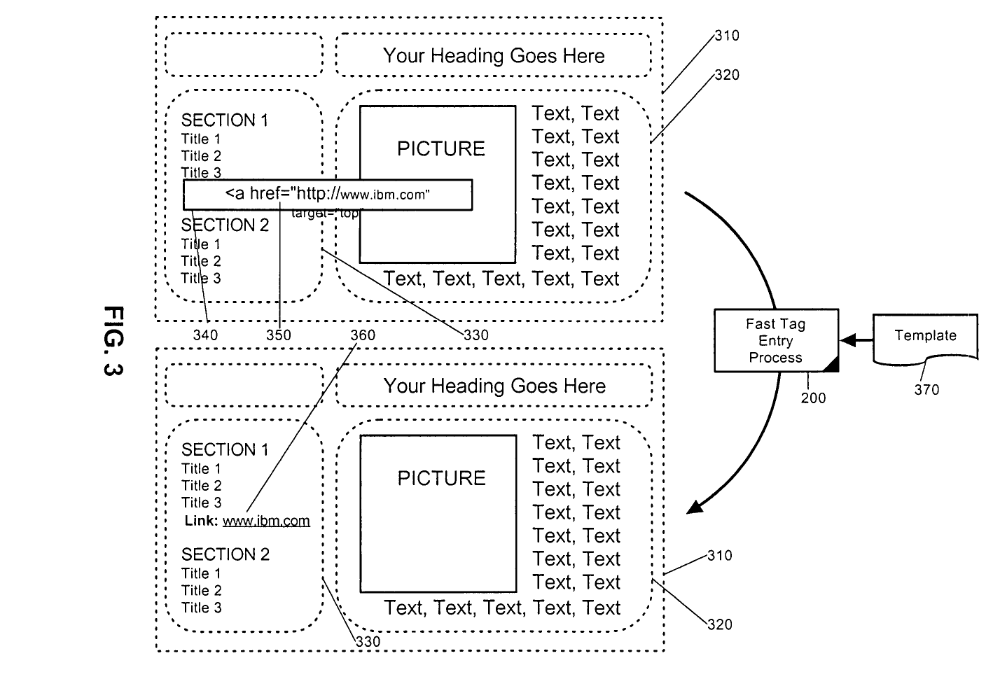

In further illustration, FIG. 3 is a pictorial illustration of a WYSIWYG view of a multimodal markup language editor which has been configured with the fast tag entry processor 200 of FIG. 1. The WYSIWYG view 310 can include a preview area 320 in which both textual and graphical elements of the markup can be rendered. Additionally, a hierarchical representation 330 of the markup can be presented in the WYSIWYG view 310 through which modifications to the markup can be performed as new sections are inserted, modified and deleted from the markup language document. Once in the fast tag entry mode, responsive to the insertion of text in a text element in the hierarchy 330, a buffer such as a pop-up source window 340 can be created and overlain about the WYSIWYG view 310.

Within the pop-up source window 340, a tag 350 can be textual specified just as if the WYSIWYG view 310 had been supplanted with a source view. Yet, no context switch to the source view will be required. Once complete, the fast tag entry processor 200 can close the pop-up source window 340 and the WYSIWYG view 310 can be re-rendered with the modified tag 360 reflecting the textual changes made to the tag 350 in the pop-up source window 340. In this regard, one skilled in the art will recognize that a new tag can be specified in the pop-up source window 340, or an existing tag can be edited in the pop-up source window 340. Hence, prior to opening the pop-up source window 340, the fast tag entry processor 200 can parse text surrounding the insertion caret at the time of the insert event to determine if a pre-existing has been specified. If so, the textual definition of the tag can be loaded into the pop-up source window 340 for editing.

Once the developer has completed editing a tag 350 in the pop-up source window 340, one or more templates 370 can be applied to perform post-processing on the defined tag 360. For instance, where the developer merely provides the input text, “<B>” through the pop-up source window 340, a template can detect an attempt to create bold-faced text and the text, “insert text here</B>” can be appended to “<B>” to provide a valid tag complete with place-holder text. When re-rendering the WYSIWYG view 310, the fast tag entry processor 200 further can automatically select the place holder text so that the developer can directly replace the place holder text with actual text without requiring additional user interface interactions. As another example shown in FIG. 3, a template can specify optional text to be appended to a tag, such as the textual identification of a hyperlink based upon the text of the hyperlink itself.

Significantly, in a preferred aspect of the present invention, the fast tag insertion process can be configured for operation with ordinary text modification convenience tools, such as auto-completion and content assist. Specifically, in regard to content assist, the fast tag entry processor 200 can monitor events in the WYSIWYG view 310 of the multimodal markup language document editor. Upon detecting an insertion event such as when the end user places an insertion caret amidst text within a text element of the hierarchy 330 of the WYSIWYG view 310, the fast tag entry process 310 can parse the text element and can create a temporary copy of the actual markup which can be provided to a content assist engine. In this way, the full functionality of the content assist engine can be supported without the pop-up source window 340.

The present invention can be realized in hardware, software, or a combination of hardware and software. An implementation of the method and system of the present invention can be realized in a centralized fashion in one computer system, or in a distributed fashion where different elements are spread across several interconnected computer systems. Any kind of computer system, or other apparatus adapted for carrying out the methods described herein, is suited to perform the functions described herein.

A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which, when loaded in a computer system is able to carry out these methods.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form. Significantly, this invention can be embodied in other specific forms without departing from the spirit or essential attributes thereof, and accordingly, reference should be had to the following claims, rather than to the foregoing specification, as indicating the scope of the invention.

1. A multimodal markup language document editor configured for fast tag entry, said editor comprising:
a plurality of views, said views comprising at least one source view and at least one What You See Is What You Get (WYSIWYG) view;
a fast tag entry processor coupled both to said WYSIWYG view and said source view, said processor having a configuration for creating a text input buffer in said WYSIWYG view, said processor having a further configuration for inserting a tag definition specified in said buffer into a markup language document in the editor, and causing said WYSIWYG view to re-render a representation of said markup language document to reflect said specified tag definition.

2. The document editor of claim 1, wherein said buffer is a pop-up source window

3. The document editor of claim 1, wherein said buffer supports inline text insertion in said WYSIWYG view

4. The document editor of claim 1, wherein said buffer is coupled to a content assist engine.

5. The document editor of claim 1, further comprising a plurality of templates specifying changes to a defined tag based upon matching text in said defined tag.

6. A method for automatically inserting markup language tags in selected text in a markup language document comprising the steps of:
detecting an attempt to insert text in a text element of a What You See Is What You Get (WYSIWYG) view of a markup language document;
responsive to said detection, creating a buffer in said WYSIWYG view without switching to a source view;
accepting a textual definition of a tag within said buffer and applying said textual definition of said tag to said markup language document; and,
re-rendering said WYSIWYG view to reflect said applied textual definition of said tag in said markup language document.

7. The method of claim 6, further comprising the steps of:
matching at least a portion of said textual definition with a template specifying an additional textual edit to said textual definition; and,
applying said additional textual edit to said textual definition.

8. The method of claim 7, wherein said re-rendering step further comprises the step of re-positioning an insertion caret in said WYSIWYG view to reflect said applied additional textual edit to said textual definition.

9. The method of claim 7, wherein said re-rendering step further comprises the step of selecting at least a portion of said additional textual edit in said WYSIWYG view.

10. The method of claim 6, further comprising the steps of:
identifying an existing tag definition proximate to a caret insertion point associated with said detected attempt to insert text; and,
inserting a textual form of said existing tag definition in said buffer.

11. The method of claim 10, further comprising the step of providing said existing tag definition in source form to a content assist engine.

12. A machine readable storage having stored thereon a computer program for automatically inserting markup language tags in selected text in a markup language document, the computer program comprising a routing set of instructions for causing the machine to perform the steps of:
detecting an attempt to insert text in a text element of a What You See Is What You Get (WYSIWYG) view of a markup language document;
responsive to said detection, creating a buffer in said WYSIWYG view without switching to a source view;
accepting a textual definition of a tag within said buffer and applying said textual definition of said tag to said markup language document; and,
re-rendering said WYSIWYG view to reflect said applied textual definition of said tag in said markup language document.

13. The machine readable storage of claim 12, further comprising the steps of:
matching at least a portion of said textual definition with a template specifying an additional textual edit to said textual definition; and,
applying said additional textual edit to said textual definition.

14. The machine readable storage of claim 13, wherein said re-rendering step further comprises the step of re-positioning an insertion caret in said WYSIWYG view to reflect said applied additional textual edit to said textual definition.

15. The machine readable storage of claim 13, wherein said re-rendering step further comprises the step of selecting at least a portion of said additional textual edit in said WYSIWYG view.

16. The machine readable storage of claim 12, further comprising the steps of:
identifying an existing tag definition proximate to a caret insertion point associated with said detected attempt to insert text; and,
inserting a textual form of said existing tag definition in said buffer.

17. The machine readable storage of claim 16, further comprising the step of providing said existing tag definition in source form to a content assist engine.
